(19) United States
(12) Patent Application Publication
(10) Pub. No.: US 2011/0138118 A1
(43) Pub. Date: Jun. 9, 2011

(54) MEMORY DISC COMPOSITION METHOD AND APPARATUS USING MAIN MEMORY

(75) Inventor: Seung Kook CHEONG, Daejeon (KR)

(73) Assignee: Electronics and Telecommunications Research Institute, Daejeon (KR)

(21) Appl. No.: 12/877,303

(22) Filed: Sep. 8, 2010

(30) Foreign Application Priority Data
Dec. 4, 2009 (KR) 10-2009-0119803

(51) Int. Cl. G06F 12/02; G06F 12/00; G06F 12/16

(52) U.S. Cl. 711/112; 711/170; 711/162; 711/E12.001; 711/E12.002; 711/E12.103

(57) ABSTRACT

Provided is a memory disc composition method and apparatus using a main memory. The memory disc composition method configures a disc using the main memory in an x86 based Linux operating system (OS) by excluding an area to be used by the OS from the main memory and fixing a remaining memory for the disc. The main memory, such as an RAM, has a volatile data storage area and thus, the memory composition apparatus backs up data in real-time without decreasing a speed of a read operation and a write operation of a disc memory and restores data in the same area when an error occurs, to overcome a volatile attribute.

### CROSS-REFERENCE TO RELATED APPLICATION

This application claims the benefit of Korean Patent Application No. 10-2009-0119803, filed on Dec. 4, 2009, in the Korean Intellectual Property Office, the disclosure of which is incorporated herein by reference.

### BACKGROUND

1. Field of the Invention

The present invention relates to a memory disc composition method and apparatus that uses a portion of a main memory as a disc.

2. Description of the Related Art

Generally, a memory of a processor may be used for processing data in an operating system. Specifically, the operating system may manage the memory, and thus, a device driver or an application program may indirectly use the memory but may not directly use the memory. A portion of the memory is allocated as a random access memory (RAM) disc to improve a speed of a disc indirectly because a performance of the disc is relatively slower than the processor.

The RAM disc may maximumly use a memory bandwidth of the processor and may quickly process data. However, a portion that is dynamically allocated from a system memory is used as the RAM disc, and thus a capacity may be limited. Also, due to a structure of the RAM disc, the RAM disc has a difficulty in restoring contents when the contents are gone since an access to the dynamically allocated memory is impossible when a sudden error occurs in a system.

A hard disc may have not a comparatively huge capacity limit and may store data until an error occurs. The hard disc has an advantage of being inexpensive and has a disadvantage of being slow and being vulnerable to vibration due to attributes of a hard disc that mechanically controls a rotating magnetic disc. Currently, a solid state drive (SSD) to mitigate the disadvantage of the hard disc is released by major companies including Samsung, Intel, Micron, and the like.

Although the SSD having a relatively high data processing speed, a low power consumption, a low heat generation, a low noise, a light weight, and a small size is manufactured, the SSD falls short of expectations since a price of the SSD is high, and a data access speed with respect to a successive read and write is slow compared with the hard disc.

### SUMMARY

An aspect of the present invention provides a memory disc composition method and apparatus that easily restore data based on a fixed memory address when an error occurs, since a disc memory is independent of a system memory as opposed to being allocated from the system memory by an operating system.

Another aspect of the present invention also provides a memory disc device driver configuration scheme based on an operating system to improve a capacity limit of a conventional RAM disc and provides a memory disc composition apparatus and apparatus including a real-time data backup and restoration function to overcome a disadvantage of a non-volatile memory where data loss occurs when an error occurs.

According to an aspect of the present invention, there is provided a memory disc composition apparatus, and the apparatus includes a system memory to receive a first area of a main memory to use the first area for an operating system, and a disc memory to receive a second area of the main memory that is a remaining area excluding the first area, to use the second area for storing data.

The disc memory may copy the stored data to back up the copied data in a non-volatile disc as backup data.

When the backup data stored in the non-volatile disc is different from the stored data, the disc memory may copy the stored data to back up the copied data in the non-volatile disc as backup data.

The disc memory may copy the backup data from the non-volatile memory to restore the data.

The disc memory may be independent of the system memory, and may maintain a fix memory address to restore the backup data in the same fix memory address.

The disc memory may be one-to-one mapped to a disc memory input/output driver.

According to an aspect of the present invention, there is provided a memory disc composition apparatus, and the apparatus includes a disc memory to store data, a disc memory input/output driver to manage the disc memory and to provide an application programming interface (API) for a block device driver, and the block device driver to provide another API for a file system, and to use the disc memory input/output driver.

According to an aspect of the present invention, there is provided a memory disc composition method, and the method includes allocating a first area of a main memory as a system memory, allocating, as a disc memory, a second area of the main memory that is a remaining area excluding the first area, and backing up or restoring data stored in the disc memory.

Additional aspects, features, and/or advantages of the invention will be set forth in part in the description which follows and, in part, will be apparent from the description, or may be learned by practice of the invention.

### EFFECT

According to an embodiment, a read operation and a write operation may be improved compared with a conventional hard disc and a disc may be operated by only utilizing a memory. A system may be configured in the same manner as a conventional computer and thus, the system may have an improved disc and may be applicable to a storage server, an entertainment service, and the like without modifying an application program.

According to an embodiment, a hard disc may be replaced with a high-speed memory disc. A system may be configured to have a light weight, a low noise, a low power consumption, and a high performance, and a plurality of users access the system and perform a relatively prompt read operation and a relatively prompt write operation of multiple data.

According to an embodiment, compared with a conventional hard disc, a memory having a relatively long lifespan, such as a random access memory (RAM), is used and thus, a system may be easily corrected, and may be configured as a large capacity storage system using a communication interface and a network connected through a high-speed input/output device.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a boot process of a memory disc composition apparatus according to an embodiment of the present invention;

FIG. 2 is a diagram illustrating a memory map of a memory disc composition apparatus according to an embodiment of the present invention;

FIG. 3 is a diagram illustrating a memory configuration of a memory disc composition apparatus according to an embodiment of the present invention;

FIG. 4 is a diagram illustrating a functional hierarchical configuration of operating software of a memory disc composition apparatus according to an embodiment of the present invention;

FIG. 5 is a flowchart illustrating a process to back up or to restore data stored in a disc memory of a memory disc composition apparatus according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

According to an embodiment, a read-and-write random access memory (RAM) that has a high speed in performing functions such as data access, read, write, and the like, has a low power consumption, a low heat generation, a low noise, and is strong against vibration may be used, as a memory disc composition apparatus, among apparatuses storing and processing data, to overcome disadvantages of a hard disc, such as a relatively low data processing speed, a high power consumption, a high heat generation, a noise, and the like.

According to an embodiment of the present invention, a memory disc composition apparatus may have a backup program operating in a background to preserve contents of a volatile memory used in a disc, and a performing of a reading operation and a writing operation of the memory may be improved by a direct access.

According to an embodiment of the present invention, a memory disc composition apparatus may easily change a capacity between a main memory and a memory disc, and may add a memory to increase a capacity of the memory disc or a capacity of the main memory.

According to an embodiment of the present invention, a memory disc composition apparatus may be configured as a large capacity storage system based on a communication interface and a network connected through a high-speed input/output device.

According to an embodiment of the present invention, a memory disc composition apparatus may configure a disc memory as a dynamic random access memory (DRAM) based solid state disc (SSD).

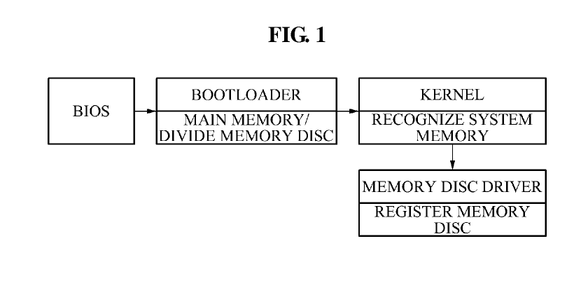

FIG. 1 illustrates a boot process of a memory disc composition apparatus according to an embodiment of the present invention.

Referring to FIG. 1, when a power is provided to the memory disc composition apparatus, memory disc composition apparatus may load a bootloader from a boot block through a Basic Input Output System (BIOS). The bootloader may initiate the memory disc composition apparatus and may pass a kernel parameter to a kernel. The kernel parameter may be used as a parameter of the initiation of the memory disc composition apparatus when the kernel is booted. When a value of a parameter of the bootloader is changed, the bootloader may separate a main memory and a memory disc, and may pass the kernel parameter to the kernel. In this case, the memory disc indicates a state of a memory before being used as a disc.

The kernel may initiate the memory disc composition apparatus using the kernel parameter, and may configure a system memory map as a reserved space separated from a system memory using a parameter associated with the memory. In this case, the kernel may only manage a system memory area. A memory disc driver may utilize the reserved space separated from the system memory to register and to operate the memory disc as a disc device. When the registration is completed, a user may use a portion of the main memory at a fixed location as a disc memory. In this case, the disc memory indicates a state of the memory after being a disc.

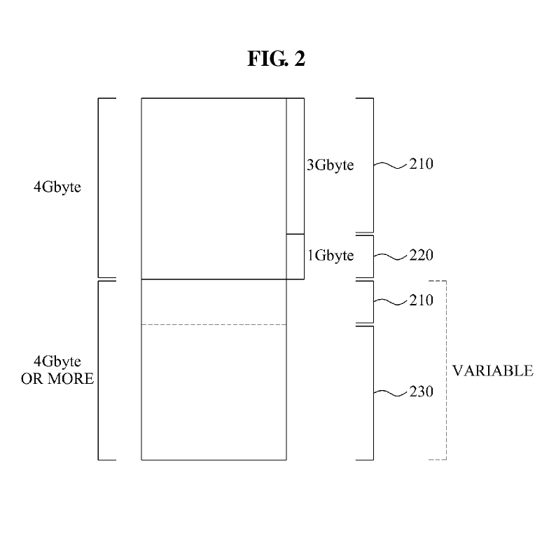

FIG. 2 illustrates a memory map of a memory disc composition apparatus according to an embodiment of the present invention.

Referring to FIG. 2, when a 64-bit processor is used, a system memory map of 4 GB may configure an initial 1 MB as a BIOS/video memory reserved space, about 3 GB as a space for a system memory 210, and about 1 GB as a space for a peripheral device 220 such as a Peripheral Component Interconnect (PCI), Universal Serial Bus (USB), and the like.

Both a 64-bit system and a 32-bit system use the system memory map. The 64-bit system may include a main memory of 4 GB or more, and thus, a system memory area and a disc memory area may be separately used in an area where a capacity is greater than or equal to 4 GB.

In this case, according to a total capacity of the main memory contained in a memory slot of the system, an initial system memory of 3 GB, namely a first area, and an extended system memory may be excluded, and a remaining memory area, namely a second area may be used as a disc memory. Specifically, the memory disc composition apparatus may determine a capacity of a disc memory 230, namely the second area, may be determined based on a capacity of the system memory 210 of 4 GB or more.

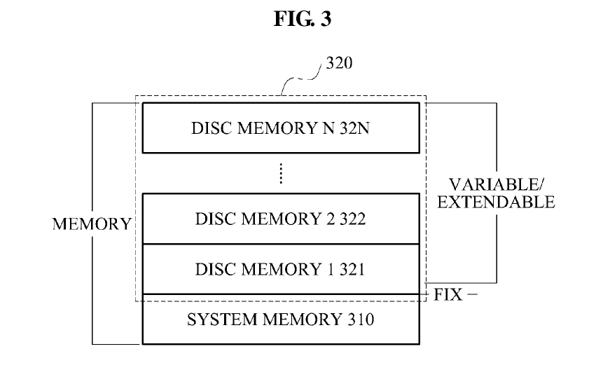

FIG. 3 illustrates a memory configuration of a memory disc composition apparatus according to an embodiment of the present invention.

Referring to FIG. 3, the memory disc composition apparatus may include a system memory 310 and a disc memory 320, and the system memory 310 may use an allocated first area of a main memory for an operating system and the disc memory 320 may use an allocated second area of the main memory, namely an area excluding the first area, for storing data.

The system memory 310 is an area used by the operating system, and the disc memory 320 may be constituted by disc memory 1 321 through disc memory N 32N based on a composition method and may have the same fixed memory address. During an initial composition, a first area of the system memory may be fixed as a value determined by a user, and the disc memory is one-to-one mapped to a disc memory input/output driver.

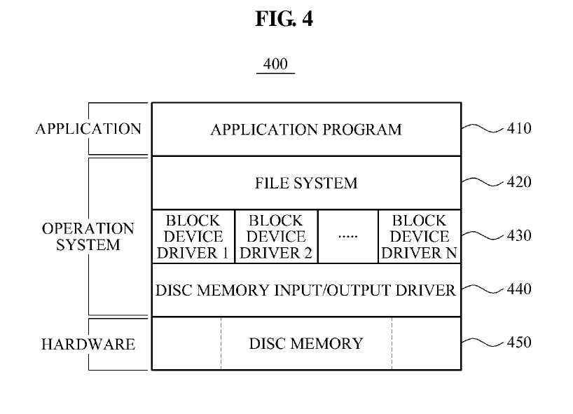

FIG. 4 illustrates a functional hierarchical configuration of operating software of a memory disc composition apparatus 400 according to an embodiment of the present invention.

Referring to FIG. 4, the memory disc composition apparatus 400 may be configured to include an application program, an operating system, and hardware, and more particularly, may be configured to include a disc memory 450, a disc memory input/output driver 440 managing the disc memory, a block device driver 430, a file system 420, and an application program 410.

The disc memory input/output driver 440 may perform a read operation or a write operation to the disc memory 450 based on an indirect address access scheme to access the disc memory 450, and may provide an application programming interface

(API) for the block device driver 430.

The block device driver 430 may provide another API for the file system 420 and may use the disc memory input/output driver 440. When the disc memory 450 is constituted by a single disc memory, one block device driver is loaded in a system memory, and when the disc memory 450 is constituted by N disc memories, N block device drivers are loaded in the system memory.

The file system 420 may provide another API for the application program 410 to enable a user to access the disc memory 450. Accordingly, the memory disc composition apparatus 400 may set each partition and each boot up and may be operated as a conventional hard disc.

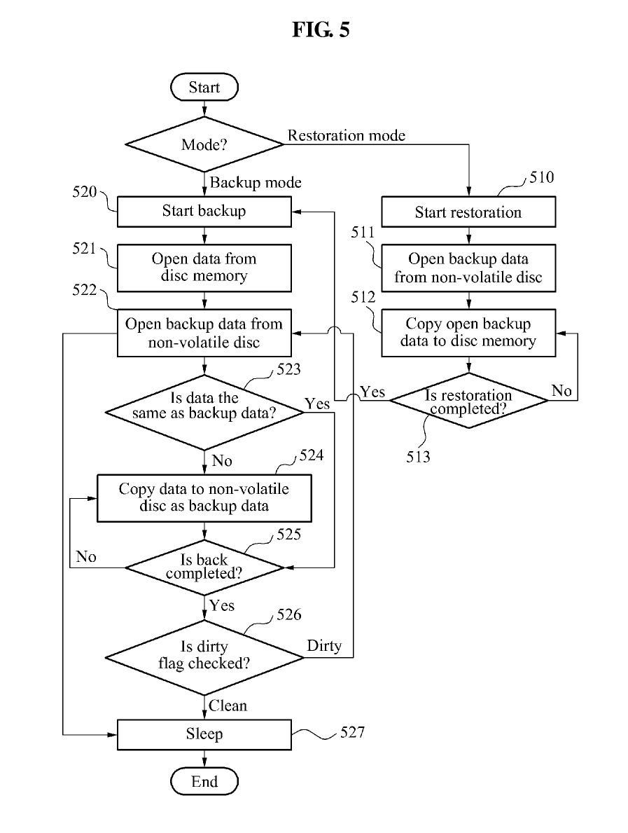

FIG. 5 illustrates a process to back up or to restore data stored in a disc memory of a memory disc composition apparatus according to an embodiment of the present invention.

A backup or restoration of data of the memory disc composition apparatus may be performed as a background in an application level. A backup and restoration program may include a backup mode to preserve data and a restoration mode to restore backup data to a state before an error occurs, in the case an error occurs in data used by the disc memory 320.

The restoration mode may read the backup data from a non-volatile disc, for example a hard disc, and may copy the backup data to the disc memory 320 to restore an existing partition, an existing file system, an existing file, an existing directory, and the like to a state before the error occurs. When the restoration is completed, the backup mode is immediately performed to back up a block device.

A backup routine may be performed during a predetermined time, and an operation of the backup may process a change in the disc memory 320 based on a block unit, may output a dirty flag or a clean flag based on an existence of the change, and may process a matter corresponding to the dirty flag or a matter corresponding to the clean flag. The backup may be performed only with respect to the dirty flag and thus, an unnecessary operation may be eliminated.

Whether the backup and restoration program is operated as the backup mode after the restoration or is operated as only the backup mode may be determined based on a demand of a user.

When the backup and restoration program is started from the restoration mode in operation 510, the memory disc composition apparatus may open backup data from a non-volatile disc in operation 511. The memory disc composition apparatus copies the open backup data to the disc memory 320 as data in operation 512. After all backup data is stored in the disc memory 320 in operation 513, the restoration mode may automatically proceed with the backup mode.

When the backup and restoration program is started from the backup mode in operation 520, the memory disc composition apparatus may perform a backup without a restoration. The memory disc composition apparatus opens data stored in the disc memory 320 in operation 521. The memory disc composition apparatus may read contents of the data based on a page unit of 4096 bytes. The memory disc composition apparatus opens backup data stored in the non-volatile disc in operation 522.

The memory disc composition apparatus determines whether contents of the backup data stored in the non-volatile disc is the same as the open data in operation 523. When the contents of the backup data is different from the open data, the memory disc composition apparatus copies the data stored in the disc memory 320 to the non-volatile disc as backup data in operation 524. In this case, when the copying and the backup is completed in operation 525, the memory disc composition apparatus may set a dirty flag, and when the backup is not completed, the memory disc composition apparatus may set a clean flag. Specifically, the memory disc composition apparatus checks the dirty flag in operation 526. When the backup is not normally completed, the memory disc composition apparatus may set the dirty flag, and when the backup is normally completed, the memory disc composition apparatus may set the clean flag to proceed with a subsequent operation.

When the dirty flag is set, the backup routine is immediately performed, and when the clean flag is set, the backup routine may sleep to wait for an operation for a predetermined time determined by the user in operation 527. The user may flexibly determine the time such as 5 seconds, 10 seconds, and the like. After the predetermined time, the memory disc composition apparatus may automatically perform the backup routine. In this case, as described above, the memory disc composition apparatus may repeatedly perform a job of comparing the data stored in the disc memory 320 and the backup data stored in the non-volatile disc and setting the dirty flag or the clean flag.

Therefore, the disc memory 320 may be configured as a DRAM based SSD.

The method according to the above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A memory disc composition apparatus, the apparatus comprising:
a system memory to receive a first area of a main memory to use the first area for an operating system; and
a disc memory to receive a second area of the main memory that is a remaining area excluding the first area, to use the second area for storing data.

2. The apparatus of claim 1, wherein the disc memory copies the stored data to back up the copied data in a non-volatile disc as backup data.

3. The apparatus of claim 2, wherein, when the backup data stored in the non-volatile disc is different from the stored data, the disc memory copies the stored data to back up the copied data in the non-volatile disc as backup data.

4. The apparatus of claim 1, wherein the disc memory copies the backup data from the non-volatile memory to restore the data.

5. The apparatus of claim 4, wherein the disc memory is independent of the system memory, and maintains a fix memory address to restore the backup data in the same fix memory address.

6. The apparatus of claim 5, wherein the disc memory is configured as a Dynamic Random Access Memory (DRAM) based Solid State Disc (SSD).

7. The apparatus of claim 1, wherein the disc memory is one-to-one mapped to a disc memory input/output driver.

8. A memory disc composition apparatus, the apparatus comprising:
a disc memory to store data;
a disc memory input/output driver to manage the disc memory and to provide an application programming interface (API) for a block device driver; and
the block device driver to provide another API for a file system, and to use the disc memory input/output driver.

9. The apparatus of claim 8, wherein the disc memory input/output driver performs a read operation or a write operation to the disc memory based on an indirect address access scheme used for accessing the disc memory.

10. The apparatus of claim 8, wherein, when the disc memory is constituted by a single disc memory, one block device driver is loaded in a system memory, and when the disc memory is constituted by N disc memories, N block device drivers are loaded in the system memory.

11. A memory disc composition method, the method comprising:
allocating a first area of a main memory as a system memory;
allocating, as a disc memory, a second area of the main memory that is a remaining area excluding the first area; and
backing up or restoring data stored in the disc memory.

12. The method of claim 11, wherein, when backup data stored in the non-volatile disc is different from the data stored in the disc memory, the backing up copies the stored data to back up the copied data in the non-volatile disc as backup data.

13. The method of claim 11, wherein the restoring copies the backup data stored in the non-volatile memory to the disc memory to restore the data.

14. The method of claim 11, further comprising:
configuring the disc memory as a DRAM based SSD.
